(19) United States
(12) Patent Application Publication
(10) Pub. No.: US 2017/0355318 A1
(43) Pub. Date: Dec. 14, 2017

(54) FLEXIBLE ADJUSTABLE HOLDER THAT ATTACHES TO SUN VISOR HARDWARE MOUNTING

(71) Applicant: Hui Lu, Wenlin (CN)

(72) Inventor: Hui Lu, Wenlin (CN)

(21) Appl. No.: 15/180,045

(22) Filed: Jun. 12, 2016

(51) Int. Cl. B60R 7/05

(52) U.S. Cl. CPC B60R 7/05

(57) ABSTRACT

A holder with a holding structure and a flexible structure that attaches to a sun visor hardware mounting and allows positioning of the holding structure independent of sun visor position and orientation.

### TECHNICAL FIELD

This invention is a holder, featuring a structure made of material which can be easily bent, and retains the new position. It attaches to a sun visor's hardware mounting in a motor vehicle and allows positional adjustment.

### BACKGROUND OF THE INVENTION

A motor vehicle's sun visor is frequently used for attaching holders for various devices, such as smartphones. Such holders require that the sun visor be lowered (e.g. flipped down) or raised (e.g. flipped up) in order to read a device's display. When the sun visor is then flipped up or down from the position in which it can be read, the device's display can no longer be read.

### BRIEF SUMMARY OF THE INVENTION

The invention herein disclosed and claimed is a holder that features a holding structure and a flexible structure and attaches to a sun visor hardware mounting.

The flexible structure is sufficiently long, flexible and stiff so as to allow the holding structure and any item held thereby to be moved with respect to the sun visor and its mounting, then remain essentially in the new position.

As such, the holder uses the sun visor's mounting as an anchor but remains independent of the position of the sun visor.

### BRIEF DESCRIPTIONS OF THE DRAWINGS

FIG. 1 depicts a motor vehicle's windshield showing right and left hand sun visors and middle location rear-view mirror. A sun visor-mounted holder is shown with sun visor in a lowered position.

FIG. 2 depicts a motor vehicle's windshield showing right and left hand sun visors and middle location rear-view mirror. A sun visor-mounted holder is shown with sun visor in a raised position.

FIG. 3 illustrates a typical sun visor and its mounting

FIG. 4 illustrates one embodiment of the invention showing a flexible structure with a holding structure on one end and a clamping mechanism on the other end.

FIG. 5 illustrates how the invention of FIG. 4 can be attached to a sun visor's mounting hardware.

FIG. 6 illustrates how the invention of FIG. 5 can have its position adjusted independent of the position of the sun visor.

FIG. 7 shows the sun visor which had been previously flipped down is now flipped up whereas the holder's position remains unchanged.

### DETAILED DESCRIPTION OF THE INVENTION

Smartphones are often used as navigational aids while driving a motor vehicle. To avoid diverting one's eyes from the road ahead, holders have been developed that attach to a sun visor and hold a smartphone or similar device in a position whereby it can be viewed when the sun visor is either raised or lowered.

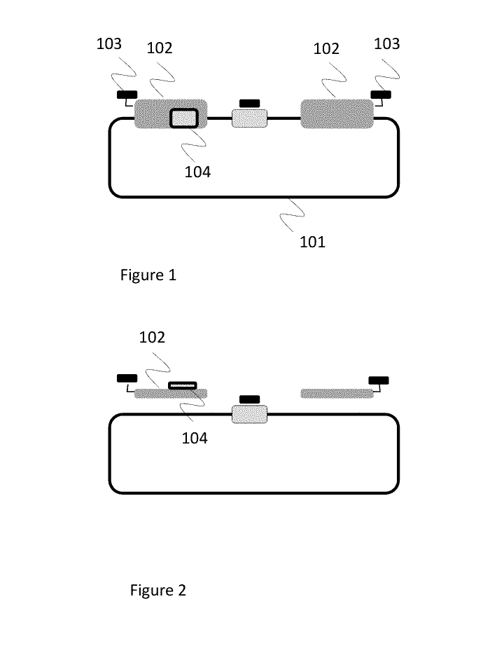

FIG. 1 illustrates a vehicle windshield (101) with typical sun visors (102) and rear-view mirror shown. The sun visors are typically mounted by a hardware fixture (103) that permits the sun visor to be flipped down or up, and moved laterally so as to block sun coming in from a nearby side window. A holder (104) that attaches to the sun visor, itself, is shown. Note that the sun visor is flipped down so that the holder and any device it is holding can be viewed. When the sun visor is flipped up and rests flush with an inside roof padding, a device held in the holder would no longer be viewable by the driver or passenger.

FIG. 2 illustrates the same windshield, sun visors and mirror as in FIG. 1 but here the sun visors (102) are flipped up. The holder (104) now faces the driver or passenger edge on. Any device that it may be holding will now be facing toward the roof and no longer be viewable by the driver or passenger.

Other sun visor holders have the opposite orientation. That is, they allow a device to be viewed when the sun visor is flipped up but are not in position to be viewed when a sun visor is flipped down.

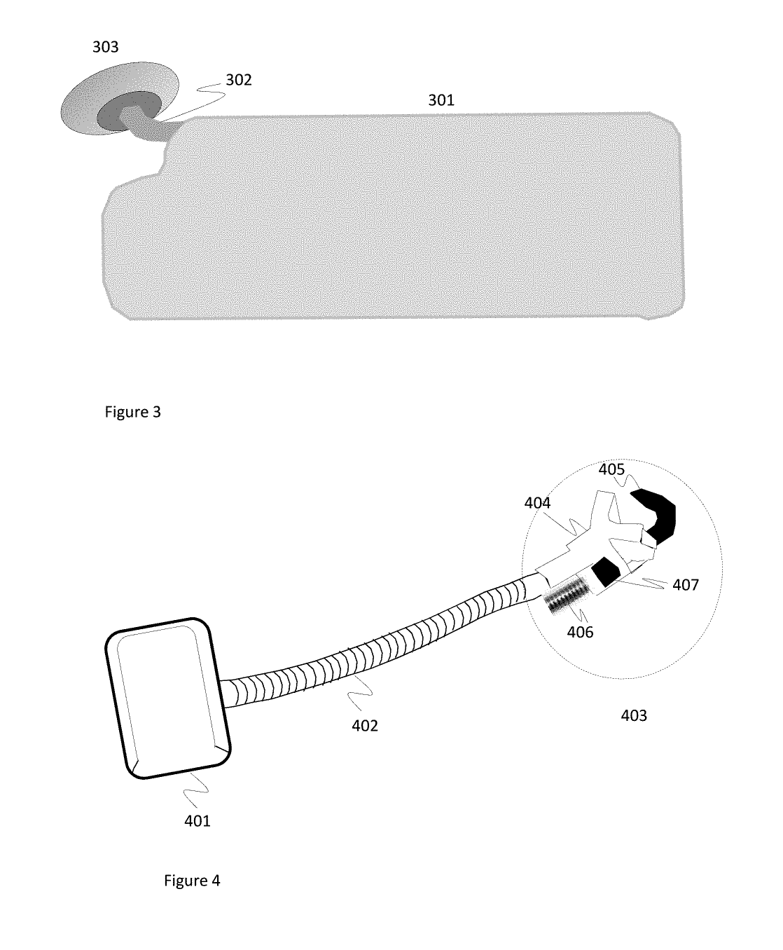

Sun visors are typically mounted to the roof of the vehicle and contain hardware that extends from the mounting and passes through one edge of a sun visor. FIG. 3 illustrates a typical sun visor showing the mounting hardware (303) and a swiveling rod (302) that extends from the housing 303 through one edge of the sun visor 301. The swiveling rod allows the sun visor to be swung, horizontally, from its position in front of the windshield to a position by a side window. The sun visor can be flipped up or down with the horizontal portion of rod 302 acting as a pivot point.

One embodiment of the invention hereby disclosed is illustrated in FIG. 4. At one end of a flexible structure (402) is a holding structure (401) that is operative to firmly hold something in place, such as a smartphone. It may also be used to hold other items. Thus, its shape and peripheral structures may vary depending upon the item it is designed to secure. At the opposite end of the flexible structure (402) is the clamping mechanism (403) comprising; a fixed housing 404, a J-shaped fixture (405) with a threaded end (406) operative to move away from or closer to the housing 404 by turning a threaded fixture 407. The threaded fixture 407 is similar in structure and function to the threaded fixture used to adjust the jaw position of a monkey wrench. The clamping mechanism 403 is small enough in size to engage the rod (302) shown in FIG. 3. Note that the portion of the housing (404) that engages the rod (302) is shaped so that it snugly interfaces to the rod (302). The size and structure of the clamping mechanism is such that it will securely attach the invention to a wide variety of sun-visor rods. This is critical in order to ensure that the invention will be applicable to essentially any sun visor and its hardware.

FIG. 5 shows the clamping mechanism's housing 404 engaging with the rod 302 and firmly secured by adjusting the J-shaped fixture with the threaded fixture 407 until the J-shaped fixture is retracted and holds the rod 302 tightly against the housing 404. Although not shown in the drawing, the J-shaped fixture and the portion of the housing 404 that contacts the sun-visor rod may be grooved so as to provide a firmer grip on that rod.

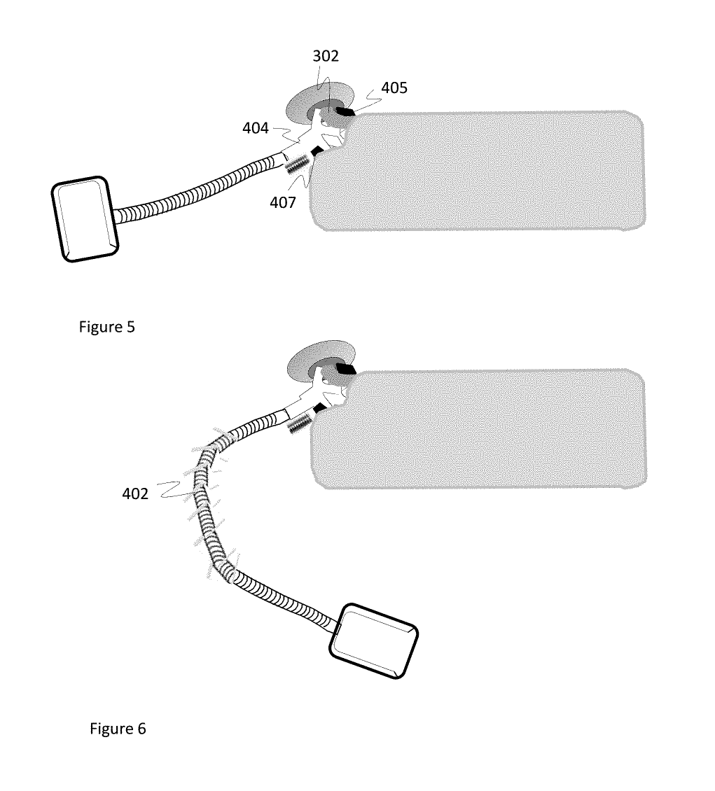

In FIG. 6, once the clamping mechanism has secured the invention firmly against the rod 302, the flexible structure 402 may be flexed so as to place the holding structure 401 into a desired position.

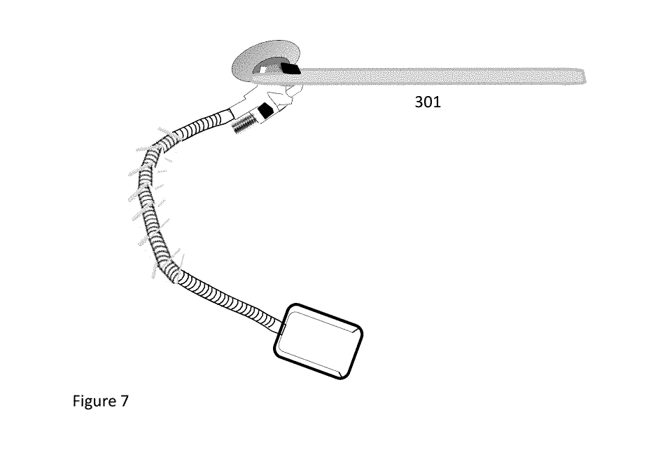

In FIG. 7, the holder's position remains unchanged whereas the sun visor has been flipped up from its position shown in FIG. 6. This illustrates the independence of holder position with respect to sun visor position.

The invention may be made of a variety of materials. For example, the holding structure could be made of plastic whereas the flexible structure and clamping mechanism could be made of metal. Alternatively, the entire invention could be made of metallic materials or sufficiently strong plastic materials.

Although the holding structure in these invention embodiments is designed to hold a smartphone, the holding structure is not constrained to holding such devices. It could be used to hold any other items to which a driver or passenger wants immediate access.

What is claimed is:

1. A device comprising:
a holder portion;
a firmly flexible gooseneck portion;
a clamping mechanism operative and sized to clamp to a sun visor hardware mounting;
said clamping mechanism attached to one end of said firmly flexible gooseneck portion;
said clamping mechanism, at end away from said firmly flexible gooseneck portion, has a fixed V-shape structure meant to be placed firmly against sun visor mounting hardware such that hardware mounting rod rests in said fixed V-shape structure;
said clamping mechanism having a J-shape structure with a threaded portion operative to be tightened against said hardware mounting rod, resting in said V-shape structure, such that when fully tight it establishes a firm anchor to said hardware mounting rod resistant to slippage;
said holder portion is firmly attached to other end of said gooseneck portion opposite the attachment point of said clamping mechanism.

2. (canceled)

3. (canceled)
